(19) United States
(12) Patent Application Publication
(10) Pub. No.: US 2005/0027771 A1
(43) Pub. Date: Feb. 3, 2005

(54) System and method for approximating division

(75) Inventor: David Chao Hua Wu, San Diego, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation

(21) Appl. No.: 10/629,797

(22) Filed: Jul. 30, 2003

(51) Int. Cl. G06F 7/38

(52) U.S. Cl. 708/446

(57) ABSTRACT

A system and method are used to perform division or complex division using multiplication and/or summation devices and steps. A numerator and denominator of a complex division signal are filtered. A separate determination of their values is performed using separate logic systems. The separate values are multiplied together for form an output signal. The denominator logic system converts the complex division signal into a signal that is processed using multiplication and summation devices. The processing adjusts an approximated past value using an error value. The error value can be based on a present value, a past value, and a scaling coefficient.

### BACKGROUND OF THE INVENTION

1. Field of the Invention

The present invention is related to a system and method for approximating division, more particularly in an FM demodulator.

2. Background Art

A secondary audio program (SAP) signal received must be processed in order to generate a pulse code modulated signal (PCM) output signal. Typically, a SAP signal is band pass filtered, FM demodulated, and processed using a variable de-emphasis algorithm to produce the PCM. The FM demodulation can be carried out using an equation FM(n)=[I(n)Q(n)−I(n)Q(n)]/[I²(n)+Q²(n)]. However, typical conventional systems only calculate the numerator and ignore the denominator because the division is too complex for their processors. This is because conventional processors do not have enough hardware and/or software support to perform such complex division. Thus, a noise signal received by a FM demodulator is passed on in the FM(n) output signal because the denominator is not calculated along with the numerator. This noise can cause problems down the line during subsequent signal processing.

Therefore, what is needed is a system and method that approximates the denominator during demodulation of an FM signal.

### BRIEF SUMMARY OF THE INVENTION

Embodiments of the present invention provide a method for approximating y(n)=1/x(n) in FM demodulation, where x(n)=I²(n)+Q²(n). A prior estimated value of 1/x(n) is received. A present value of x(n) is received. The prior estimated value of 1/x(n) is adjusted to compensate for an error between the prior estimated value of 1/x(n) and the present value of 1/x(n). The adjusted prior estimated value of 1/x(n) is output as the present value of 1/x(n).

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a system for processing a SAP signal according to an embodiments of the present invention.

FIG. 2 shows an FM demodulation system according to embodiments of the present invention.

FIG. 3 shows a portion of the FM demodulation system in FIG. 2.

FIG. 4 shows a portion of the FM demodulation system in FIG. 3.

The present invention will now be described with reference to the accompanying drawings. In the drawings, like reference numbers may indicate identical or functionally similar elements. Additionally, the left-most digit(s) of a reference number may identify the drawing in which the reference number first appears.

### DETAILED DESCRIPTION OF THE INVENTION

Overview

While specific configurations and arrangements are discussed, it should be understood that this is done for illustrative purposes only. A person killed in the pertinent art will recognize that other configurations and arrangements can be used without departing from the spirit and scope of the present invention. It will be apparent to a person skilled in the pertinent art that this invention can also be employed in a variety of other applications.

Embodiments of the present invention provide a system and method that can be used to approximate division or complex division using multiplication and/or summation devices and steps. A numerator and denominator of a complex division signal are filtered. A separate determination of their values is performed using separate logic systems. The separate values are multiplied together for form an output signal. The denominator logic system estimates the complex division signal using multiplication and summation devices. The processing adjusts an approximated past value using an error value. The error value can be based on a present value, a past value, and a scaling coefficient.

It is to be appreciated that, although the description contained herein describes an example FM demodulator system and method that are used to approximate y(n)=1/x(n) for one example of an FM(n) signal, the system and method described herein can be used to process any 1/x(n) signal using multiplication and summation devices and methods.

Overall System

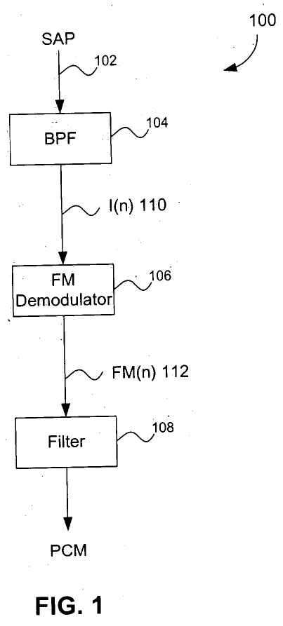

FIG. 1 shows a system 100 for processing a secondary audio program (SAP) signal 102 according to embodiments of the present invention. SAP signal 102 is processed using filter 104 (e.g., a band pass filter) to produce an input signal I(n) 110, which is input into an FM demodulator 106. I(n) 110 is processed using FM demodulator 106 to produce an FM(n) output signal 112. FM(n) is processed using a variable de-emphasis device or filter 108 to produce a pulse code modulation signal (PCM) as an output signal of system 100.

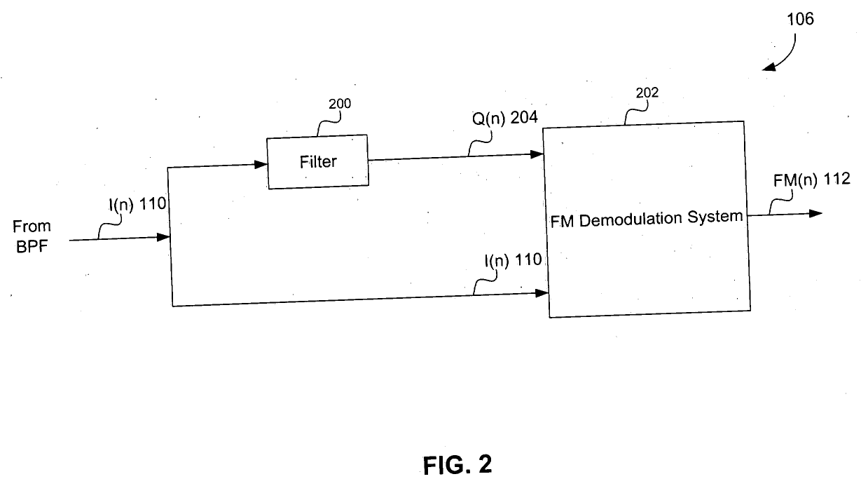

FIG. 2 shows details of FM demodulator 106 according to an embodiment of the present invention. FM demodulator 106 can include a filter 200 (e.g., a Hilbert Filter) that generates a quadrature-phase signal Q(n) 204 from I(n) 110. The signals I(n) 110 and Q(n) 204 are input into an FM demodulation system 202, which produces FM(n) output signal 112. It is to be appreciated, other system can be used that produce Q(n) 204 using other devices, as might be required depending on specific applications. These alternative systems and method are contemplated within the scope of the present invention. In an embodiment, FM demodulator system 202 processes I(n) 110 and Q(n) 204 using [I(n)Q?(n)−I(n)Q(n)]/[I²(n)+Q²(n)] to produce FM(n), where n is used to designate a time period of the variable, and is an integer equal to or greater than 0.

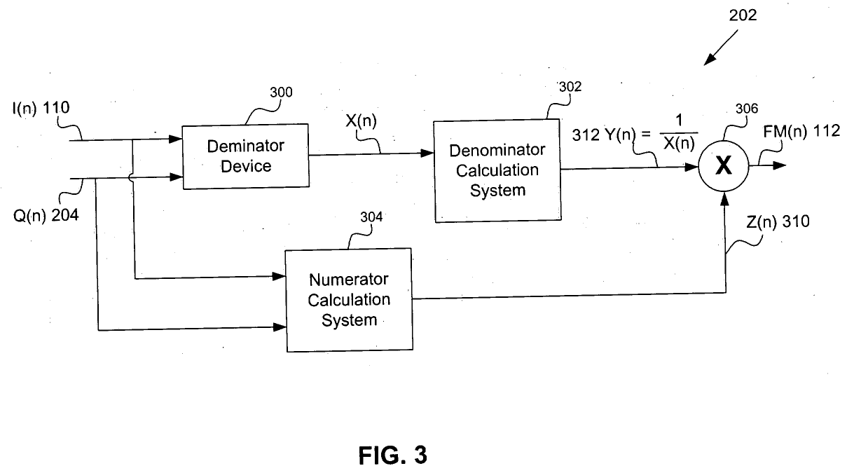

FIG. 3 shows details of FM demodulator system 202 according to an embodiment of the present invention. FM demodulator system 202 has a denominator device 300 that generates a signal X(n)=I²(n)+Q²(n). The FM demodulator system 202 also includes a denominator calculation system 302 that estimates Y(n)=1/X(n). In FIG. 3, signal Y(n) is designated 312. Denominator calculation system 302 can include multiplication and/or summation devices that can be implemented using software, hardware, firmware, or combinations thereof.

FM demodulator system 202 also includes a numerator calculating system 304 that generates an output numerator signal Z(n) 310, which is equal to [I(n)Q (n)−I (n)Q(n)]. Numerator calculation system 304 can include multiplication and/or summation devices that can be implemented using software, hardware, firmware, or combinations thereof.

The signals Y(n) 312 and Z(n) 310 are multiplied using a multiplying device 306 to generate FM(n) signal 112. In other words, FM demodulator system 202 generates the signal:
FM(n)=Y(n)Z(n)=1/X(n)*Z(n)=[1/I²(n)+Q²(n)]*[I(n)Q(n)−I(n)Q(n)]

In this case, 1/X(n) is an estimated value.

In accordance with the invention, Y(n) is presumed to be about equal to Y(n−1) (i.e., the present value is about equal to the previous value) plus an error value. In an embodiment, the error is calculated as 1−x(n)y(n−1). Also, a signal “a” can be used as a scaling coefficient that is based on the actual values being processed in logic system 302 to further adjust the error signal. In one embodiment, the scaling coefficient “a” is based on a transition speed of X(n). An accuracy of Y(n) can be increased through control of the transition speed of X(n) and the scaling coefficient “a.” Thus, Y(n)=1/X(n) is approximated as y(n−1)+(1−x(n)y(n−1))a.

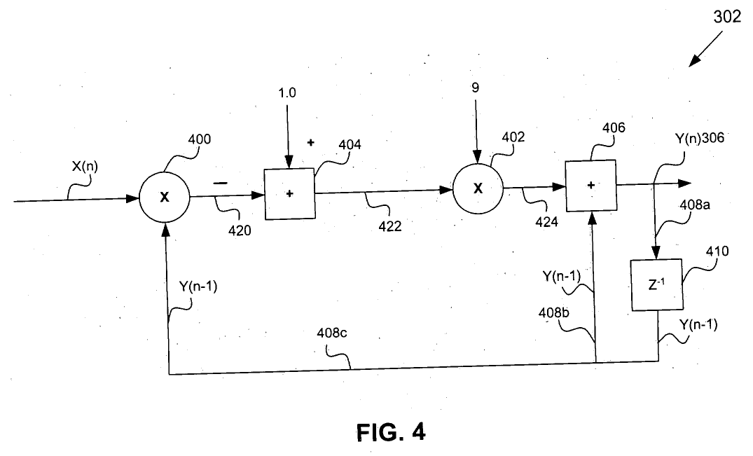

FIG. 4 illustrates an example implementation of the denominator calculating system 302 according to embodiments of the present invention. System 302 includes multiplication devices 400 and 402, summation device 404 and 406, and feedback paths 408a-408c having a delay device 410.

In operation, multiplication device 400 produces x(n)y(n−1) as signal 420. Summation device 404 produces 1−x(n)y(n−1) as signal 422. Multiplication device 402 produces (1-x(n)y(n−1))a as signal 424. Summation device 406 produces Y(n)=y(n−1)+(1−x(n)y(n−1))a.

It is to be appreciated that this is an exemplary first order logic circuit that performs division using multiplication and/or summation logic devices or steps. For example, logic system 302 could be implemented using a Infinite Impulse Response filter. Logic circuits including higher order logic circuits and/or logic circuits with multiple feedback paths can also be used. These are all contemplated within the scope of the present invention. Also, although not shown, the approximation of complex division could be implemented in hardware, such as a look-up table.

Referring back to FIGS. 1 and 2, The input SAP signal 102 and/or I(n) 110 can be a constant magnitude signal, a sine wave, a cosine, wave, or the like. Using any signal, an assumption is made that a present value is approximately equal to a previous value, possibly after adjusting the previous value for using an error signal. In other words, tracking present value to previous values using error signals for adjustment.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method for approximating y(n)=1/x(n) in FM demodulation, where x(n)=I²(n)+Q²(n), comprising:
(a) receiving a prior estimated value of 1/x(n);
(b) receiving a present value of x(n);
(c) adjusting the prior estimated value of 1/x(n) to compensate for an error between the prior estimated value of 1/x(n) and the present value of 1/x(n); and
(d) outputting the adjusted prior estimated value of 1/x(n) as the present value of 1/x(n).

2. The method of claim 1, wherein the prior estimated value of 1/x(n−1) equals 1/(I²(n−1)+Q²(n−1)), wherein I(n) is an input signal and Q(n) is a quadrature-phase signal of the input signal I(n).

3. The method of claim 2, wherein the input signal I(n) comprises a band pass filtered secondary audio program signal.

4. The method of claim 1, wherein the present value x(n) equals I²(n)+Q²(n), and wherein I(n) is an input signal and Q(n) is quadrature-phase signal of I(n).

5. The method of claim 4, wherein the input signal I(n) comprises a band pass filtered secondary audio program signal.

6. The method of claim 1, wherein an error signal equals (1−x(n)y(n−1))a, wherein x(n)=I²(n)+Q²(n), y(n−1)=1/(I²(n−1)+Q²(n−1)), I(n) is an input signal, Q(n) is a quadrature-phase signal of the input signal I(n), and “a” is a scaling coefficient.

7. The method of claim 6, wherein the input signal I(n) comprises a band pass filtered secondary audio program signal.

8. The method of claim 1, wherein the Y(n) signal equals y(n−1)+(1−x(n)(y(n−1))a, wherein x(n)=I²(n)+Q²(n), y(n−1)=1/(I²(n−1)+Q²(n−1)), I(n) is an input signal, Q(n) is a quadrature-phase signal of the input signal I(n), and “a” is a scaling coefficient.

9. The method of claim 8, wherein the input signal I(n) comprises a band pass filtered secondary audio signal.

10. A method for demodulating an FM signal FM(n) from a secondary audio program signal, comprising:
(a) receiving in-phase I(n) and quadrature-phase Q(n) portions of the FM(n) signal
(b) generating a first portion of the FM(n) signal that is equal to I(n)Q (n)−I (n)Q(n);
(c) determining a value z(n) based on the first portion of the FM(n) signal;
(d) generating a second portion of the FM(n) signal that is equal to 1/I²(n)+Q²(n), wherein I²(n)+Q²(n) is equal to x(n) and y(n)=1/x(n);
(e) generating a value for y(n) based on 1/x(n) that equals y(n−1)+(1−x(n)y(n−1))a; and
(f) multiplying the z(n) value and the y(n) value to produce the FM(n) signal.

11. A system for approximating y(n)=1/x(n) in FM demodulation, where x(n)=I²(n)+Q²(n), comprising:
means for receiving a prior estimated value of 1/x(n);
means for receiving a present value of x(n);
means for adjusting the prior estimated value of 1/x(n) to compensate for an error between the prior estimated value of 1/x(n) and the present value of 1/x(n); and
means for outputting the adjusted prior estimated value of 1/x(n) as the present value of 1/x(n).

12. The system of claim 11, wherein the prior estimated value of 1/x(n−1) equals 1/(I²(n−1)+Q²(n−1)), wherein I(n) is an input signal and Q(n) is a quadrature-phase signal of the input signal I(n).

13. The system of claim 12, wherein the input signal I(n) comprises a band pass filtered secondary audio program signal.

14. The system of claim 11, wherein the present value x(n) equals I²(n)+Q²(n), and wherein I(n) is an input signal and Q(n) is quadrature-phase signal of I(n).

15. The system of claim 14, wherein the input signal I(n) comprises a band pass filtered secondary audio program signal.

16. The system of claim 11, wherein an error signal equals (1−x(n)y(n−1))a, wherein x(n)=I²(n)+Q²(n), y(n−1)=1/(I²(n−1)+Q²(n−1)), I(n) is an input signal, Q(n) is a quadrature-phase signal of the input signal I(n), and “a” is a scaling coefficient.

17. The system of claim 16, wherein the input signal I(n) comprises a band pass filtered secondary audio program signal.

18. The system of claim 11, wherein the Y(n) signal equals y(n−1)+(1−x(n)(y(n−1))a, wherein x(n)=I²(n)+Q²(n), y(n−1)=1/(I²(n−1)+Q²(n−1)), I(n) is an input signal, Q(n) is a quadrature-phase signal of the input signal I(n), and “a” is a scaling coefficient.

19. The system of claim 18, wherein the input signal I(n) comprises a band pass filtered secondary audio signal.

20. A method for approximating y(n)=1/x(n) in FM demodulation, where x(n)=I²(n)+Q²(n), comprising:
(a) receiving 1/x(n−1);
(b) receiving x(n);
(c) adjusting 1/x(n−1) to compensate for an error between 1/x(n−1) and 1/x(n); and
(d) outputting the adjusted 1/x(n−1) as 1/x(n).
